(19) United States
(12) Patent Application Publication
(10) Pub. No.: US 2009/0263294 A1
(43) Pub. Date: Oct. 22, 2009

(54) CHEMICAL REACTION CARTRIDGE

(75) Inventors: Hidetoshi AOKI, Tokyo (JP); Takeyuki MOGI, Tokyo (JP); Takeo TANAAMI, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION, Tokyo (JP)

(21) Appl. No.: 12/426,554

(22) Filed: Apr. 20, 2009

(30) Foreign Application Priority Data
Apr. 21, 2008 (JP) 2008-109717

(51) Int. Cl. B01J 14/00

(52) U.S. Cl. 422/129

(57) ABSTRACT

Disclosed is a chemical reaction cartridge including an elastic body as a construction material and a flow path and two or more chambers connected by the flow path formed inside the cartridge, and the cartridge is structured so as to move or block a fluid material in the flow path or the chambers by partially sealing the flow path, the chambers or both the flow path and the chambers by applying external force to the elastic body from outside, as one of the chambers, the cartridge has a reaction chamber, the reaction chamber is a chamber in which a chemical reaction of a reaction liquid to be introduced in the reaction chamber is carried out, and a specific liquid to fill a space in the reaction chamber is filled in the reaction chamber before the reaction liquid is introduced in the reaction chamber.

### BACKGROUND OF THE INVENTION

1. Field of the Invention

The present invention relates to a chemical reaction cartridge.

2. Description of Related Art

Conventionally, an inspection method to inspect the biological macromolecule such as the DNA, the RNA (mRNA, cDNA and the like), protein and the like by hybridization is well known. In JP2004-226068, a cartridge for biochip which comprises a cartridge main body formed of an elastic material and in which the hybridization treatment of biological macromolecule can be carried out is described.

In JP2005-037368, a chemical reaction cartridge which can also be used for the inspection of biological macromolecule by hybridization and the like and in which an elastic body is used as a construction material of the inner chambers and flow paths is described.

In such cartridge in which an elastic body is used as the construction material of the inner chambers and flow paths, flowing and blocking of the fluid can be carried out by squeezing the chamber or the flow path by deforming the elastic body with rollers or the like and by moving or stopping the rollers or the like in a state where the rollers are squeezing the chamber or the flow path.

However, the following problem still existed in the above prior art.

In FIGS. 3A to 3C, schematic views of a reaction chamber of the conventional cartridge for DNA detection in which hybridization is to be carried out are shown.

As shown in FIGS. 3A to 3C, a reaction chamber 1 in which the DNA chip 9 is to be housed is formed in the cartridge with a base material 5 and the like. Further, an introduction path 2 and a release path 3 are formed so as to connect to the reaction chamber 1. The base material 5 surrounding the DNA chip 9, the base material covering the upper surface of the DNA chip 9 and the base material covering the side parts and the upper parts of the introduction path 2 and the release path 3 are formed with the elastic body as one body. The bottom surface on which the DNA chip 9 is fixed may be structured by the hard rigid substrate.

Opening and closing of each of the introduction path 2 and the release path 3 is controlled by the valves 12, 13, respectively. The valves 12, 13 are members which press the elastic body by rollers, syringes or the like. A plurality of types of single-stranded DNA are placed on the DNA chip 9.

As shown in FIG. 3B, when the reaction liquid 6 including the sample DNA which is labeled by the fluorescence material is introduced in the reaction chamber 1 from the introduction path 2, the sample DNA in the reaction liquid 6 hybridizes with the single-stranded DNA on the DNA chip 9. Thereafter, as shown in FIG. 3C, the excess reaction liquid including the sample DNA which did not hybridize is discharged from the release path 3.

However, when the reaction chamber 1 is in a condition as shown in FIG. 3A, a gas 7 which is air or the like exists in the reaction chamber 1. Therefore, as shown in FIG. 3B, the gas 7 which is air or the like becomes bubbles 8 and mix with the reaction liquid 6, and there is a problem that the uniformity of reaction in the hybridization is inhibited.

### SUMMARY OF THE INVENTION

In view of the problem in the prior art, the object of the present invention is to provide a chemical reaction cartridge which can maintain the uniformity of reaction in the reaction chamber in which a predetermined chemical reaction is to take place in a good condition by avoiding the mixing of gaseous matter at the time of reaction.

According to a first aspect of the present invention, there is provided a chemical reaction cartridge comprising an elastic body as a construction material and a flow path and two or more chambers connected by the flow path formed inside the cartridge, and the cartridge is structured so as to move or block a fluid material in the flow path or the chambers by partially sealing the flow path, the chambers or both the flow path and the chambers by applying external force to the elastic body from outside, as one of the chambers, the cartridge has a reaction chamber, the reaction chamber is a chamber in which a chemical reaction of a reaction liquid to be introduced in the reaction chamber is carried out, and a specific liquid to fill a space in the reaction chamber is filled in the reaction chamber before the reaction liquid is introduced in the reaction chamber.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIGS. 1A to 1E are schematic views of a reaction chamber of a chemical reaction cartridge according to an embodiment of the present invention in which a hybridization is carried out;

FIG. 2 is a graph showing fluorescence light amounts in the present invention and in a prior art; and

FIGS. 3A to 3C are schematic views of a reaction chamber of a conventional cartridge for DNA detection in which a hybridization is carried out.

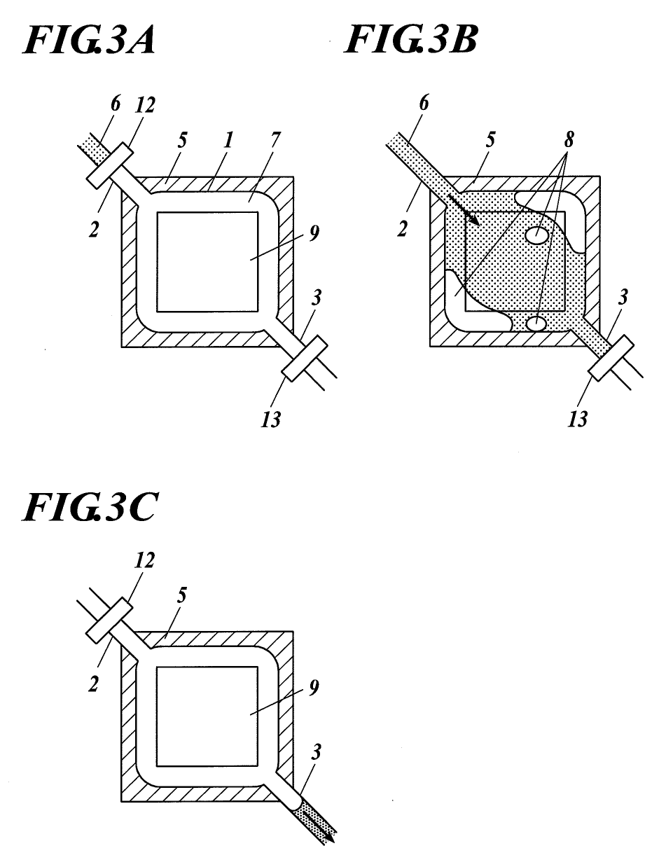

### DESCRIPTION OF THE PREFERRED EMBODIMENT

Hereinafter, an embodiment of the present invention will be described with reference to the drawings. The following is one embodiment of the present invention and does not limit the present invention. Here, the chemical reaction cartridge of the present invention is a cartridge which is applied as a reaction device generally called as “micro reactor”. The present invention is not limited to a particular usage.

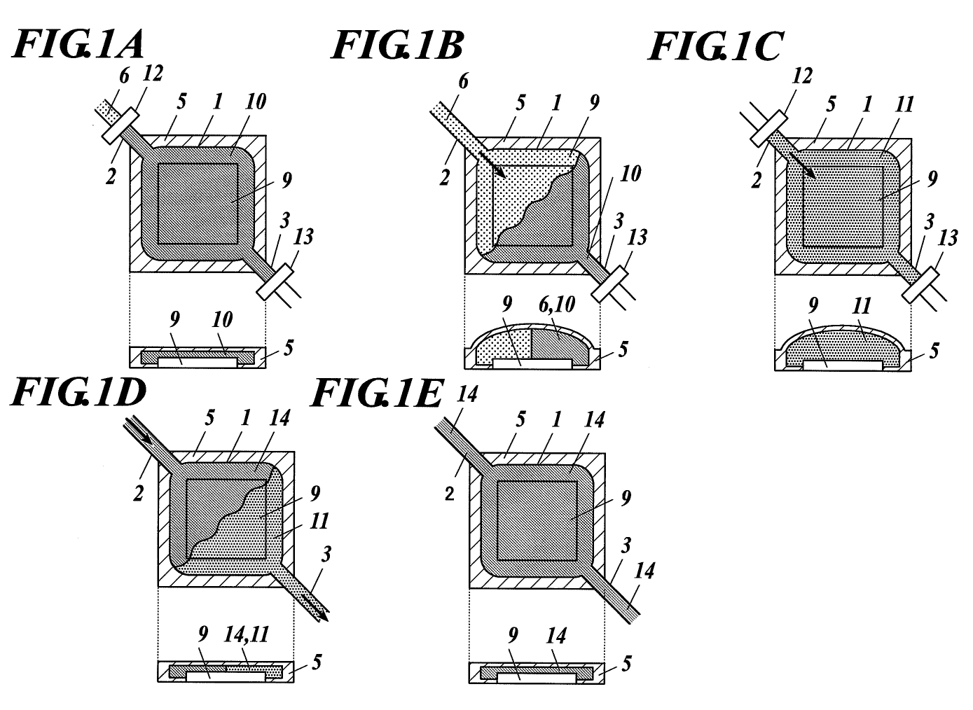

In FIGS. 1A to 1E, schematic views of the reaction chamber of the chemical reaction cartridge according to the embodiment of the present invention in which the hybridization is carried out are shown.

The chemical reaction cartridge is formed with an elastic body such a rubber and the like having airtightness and elasticity and a rigid substrate formed of hard material for positioning and for maintaining the shape.

As for a material for the elastic body, silicon rubber, PDMS (polymethylsiloxane), natural rubber and a polymer thereof, acrylic rubber, urethane rubber and the like are used.

As for a material for the substrate, glass, metal, hard resin or a rigid body which can be bent can be used.

A concave portion is formed on one surface of the elastic body, and flow paths and chambers are formed by the portion excluding the concave portion of the surface of the elastic body in which the concave portion is formed being adhered to a surface of the substrate. Two or more chambers are formed. The flow paths connect between the chambers and allow a material to move between the chambers. The material to be moved is a material having fluidity, liquid or other fluid material. When the reactant which is targeted to be moved is a material which does not flow such as a solid substance or the like or which is hard to flow, a solution including the reactant will be put in the chamber.

The flow paths and the chambers may be formed so that the elastic body covers the entire flow paths and the chambers, or the flow paths and the chambers may be structured so that a portion of the wall portion is formed with the elastic body. By inserting another layer of elastic body between the substrate and the elastic body, the flow paths and the chambers can be formed so that the elastic body covers the entire flow paths and chambers. Further, the flow paths and chambers may be structured without the rigid substrate by using an elastic body instead of the substrate.

Moving of the material is carried out in the following manner.

First, a pressing unit such as a roller, a squeegee, a syringe or the like is pressed against the elastic body above the flow path or the chamber to squeeze the flow path or the chamber. By squeezing the flow path or the chamber, the material inside the flow path or the chamber can be made to flow and move. Further, by moving the pressing position, the material inside the flow path or the chamber is made to flow and the material can be moved in the moving direction of the pressing position. It is preferred that the moving of the pressing position is carried out in a condition were the inner space is blocked by the inner walls of the flow path or the chamber which are facing one another contacting each other at the pressing position.

The blocking of the material is carried out by blocking the inner space by making the inner walls of the flow path or the chamber which face one another to contact each other by the pressing unit. By using a plurality of pressing units, while moving the material by one of the pressing units, the material can be prevented from moving further by the other of the pressing units pressing the flow path or the chamber at the position forward in the moving direction.

Based on the above described moving and blocking of the material, moving of the material inside the cartridge is controlled.

According to the above principle, moving of the material inside the chemical reaction cartridge is controlled and the operation for chemical reaction is carried out. In the following embodiment, a description will be given by taking the hybridization of DNA as an example of a chemical reaction.

As shown in FIGS. 1A to 1E, in the chemical reaction cartridge, the reaction chamber 1 in which the DNA chip 9 is to be housed is formed with the base material 5 and the like. Further, the introduction path 2 and the release path 3 are formed so as to connect to the reaction chamber 1. The base material 5 surrounding the DNA chip 9, the base material covering the upper surface of the DNA chip 9 and the base material covering the side parts and the upper parts of the introduction path 2 and the release path 3 are formed with the above described elastic body as one body. The bottom surface on which the DNA chip 9 is fixed is structured by the above described rigid substrate.

Opening and closing of each of the introduction path 2 and the release path 3 is controlled by the valves 12, 13, respectively. The valves 12, 13 are members which press the elastic body by a roller, a syringe or the like. A plurality of types of single-stranded DNA are placed on the DNA chip 9.

As shown in FIG. 1A, a specific liquid (hereinafter, called a filler liquid) to fill the spaces in the reaction chamber 1 is filled in the reaction chamber 1 before the reaction liquid 6 is introduced in the reaction chamber 1. The filler liquid 10 is to have the same composition as the component of the reaction liquid 6 in which the sample DNA, which is the reactant, is eliminated. Gaseous matter such as air or the like is kept out from the reaction chamber 1 by the filler liquid 10 being filled in the reaction chamber 1. Amount of the filler liquid 10 is to be smaller or equal to the reaction liquid 6 which is to be introduced in the reaction chamber 1. This is to prevent the reaction liquid 6 from being overly diluted.

As shown in FIG. 1B, the introduction path 2 is opened to introduce the reaction liquid 6 which includes the sample DNA being labeled by fluorescent material or the like in the reaction chamber 1 from the introduction path 2.

One of the methods to introduce the reaction liquid 6 is a method to introduce the reaction liquid 6 in the reaction chamber 1 without discharging the filler liquid 10 from the reaction chamber 1 by keeping the valve 13 closed at the time of introduction of the reaction liquid 6. In this case, the volume of the reaction chamber 1 is increased and the reaction liquid 6 for the amount of the volume which is increased in the reaction chamber 1 is accepted. At this time, a pressure to push the reaction liquid 6 to the reaction chamber 1 is applied from the introduction path 2 side. The pressure is generated by the roller or the like in advance or at the time of introduction of the reaction liquid 6 in the introduction path 2 side. As shown in FIG. 1B, when the reaction liquid 6 is introduced in the reaction chamber 1 by pressure, the sectional area of the flow path of the reaction chamber 1 is enlarged by the deformation of the elastic body which forms the reaction chamber 1 and the volume of the reaction chamber 1 increases, and the reaction chamber 1 receives the reaction liquid 6. As shown in FIG. 1C, the reaction liquid 6 and the filler liquid 10 are mixed by the inflow of the reaction liquid 6, and the liquid mixture 11 is formed.

Another method to introduce the reaction liquid 6 is a method to discharge the filler liquid 10 by opening the valve 13 for a certain amount of time at the time of introduction of the reaction liquid 6 and to receive the reaction liquid 6 for the amount equal to the discharged amount of the filler liquid 10 in the reaction chamber 1.

In the former method, all of the filler liquid 10 remains in the reaction chamber 1. However, in the later method, a portion of the filler liquid 10 can be discharged. In the later method, there is a possibility that a portion of the reaction liquid 6 may be discharged from the reaction chamber 1 before the reaction is completed. However, in the former method, the possibility of a portion of the reaction liquid 6 being discharged from the reaction chamber 1 before the reaction is completed can be surely prevented.

Both the former method and the later method may be carried out. That is, in this case, the amount of reaction liquid 6 corresponding to the sum of the amount of volume increase of the reaction chamber 1 and the amount of the filler liquid 10 which is discharged from the reaction chamber 1 is to be introduced in the reaction chamber 1.

As time passes after the reaction liquid 6 is introduced, the sample DNA in the reaction solution 6 hybridizes with the single-stranded DNA on the DNA chip 9. When the mixing by the inflow of the reaction liquid 6 is not sufficient, mixing of the reaction liquid 6 and the filler liquid 10 is facilitate in order to equally distribute the sample DNA. In such case, one of the effective methods is to facilitate the mixing by making a flow to occur in the liquid inside by moving the liquid back and forth along the flow paths 2, 3 in a state where the valves 12, 13 are pressing the flow paths 2, 3. The liquid in the reaction chamber 1 can be stirred by applying vibration by another actuator such as an oscillator using electromagnetic or the like without moving the valves.

Thereafter, as shown in FIG. 1D, the liquid mixture 11 is discharged from the release path 3 by opening the release path 3 and introducing the cleaning liquid 14 from the introduction path 2. As a result, as shown in FIG. 1E, the liquid mixture 11 is discharged from the reaction chamber 1 and the cleaning liquid 14 will be filled in the reaction chamber 1.

As described above, by filling the reaction chamber 1 with the filler liquid 10 before the reaction liquid is introduced in the reaction chamber 1, gaseous matter such as air or the like can be prevented from mixing in the reaction liquid 6 at the time of reaction and the uniformity of the hybridization between the DNA in the reaction liquid 6 and the DNA on the DNA chip 9 can be maintained in a good condition.

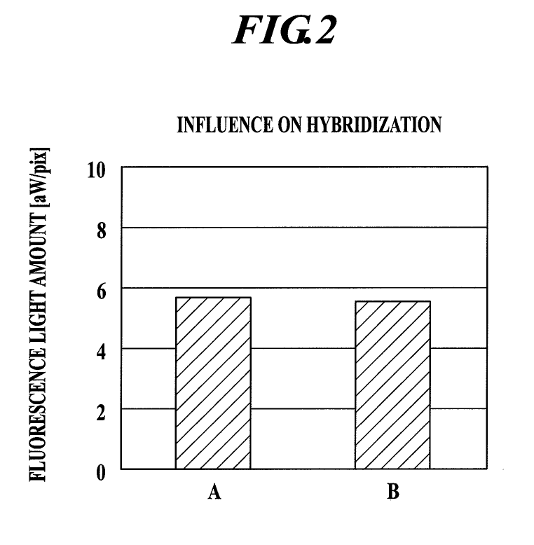

FIG. 2 is a graph showing a relation between the existence or nonexistence of the filler liquid 10 and the fluorescence light amount. Bar graph A shows the measurement result of the fluorescence light amount when the filler liquid does not exist according to a prior art, and bar graph B shows the measurement result of the fluorescence light amount when the filler liquid exists according to the present invention. The salt concentration composition of the reaction liquid 6 and the filler liquid 10 which are to be used are made to be the same, and excess liquid mixture 11 including the sample DNA which did not hybridize is discharged from the release path 3 as shown in FIG. 1D. Thereafter, the excitation light is irradiated to the DNA chip 9 and the fluorescence light amount which is emitted is measured. As a result, as shown in FIG. 2, the existence or nonexistence of the filler liquid was not found to have influence on the hybridization.

In the above embodiment, the description is given by taking the hybridization between the DNA fixed on the DNA chip which is placed in the reaction chamber and the DNA in the liquid which is to be introduced in the reaction chamber as the chemical reaction which is to be carried out in the present invention. However, the present invention can be preferably applied to a bonding between a material fixed on a chip which is placed in the reaction chamber and a liquid or a material in the liquid which is to be introduced in the reaction chamber and to other chemical reactions.

Moreover, it is effective to select a liquid such as glycerol, polyethylene glycol solution or the like, for example, which has low miscibility and reactivity with the reaction liquid as the filler liquid.

Furthermore, the filler liquid 10 and the cleaning liquid 14 may be the same liquid.

According to a first aspect of the preferred embodiment of the present invention, there is provided a chemical reaction cartridge comprising an elastic body as a construction material and a flow path and two or more chambers connected by the flow path formed inside the cartridge, and the cartridge is structured so as to move or block a fluid material in the flow path or the chambers by partially sealing the flow path, the chambers or both the flow path and the chambers by applying external force to the elastic body from outside, as one of the chambers, the cartridge has a reaction chamber, the reaction chamber is a chamber in which a chemical reaction of a reaction liquid to be introduced in the reaction chamber is carried out, and a specific liquid to fill a space in the reaction chamber is filled in the reaction chamber before the reaction liquid is introduced in the reaction chamber.

Preferably, the specific liquid does not react with the reaction liquid.

Preferably, an amount of the specific liquid exists in the reaction chamber before the reaction liquid is introduced in the reaction chamber is smaller or equal to an amount of the reaction liquid to be introduced in the reaction chamber.

Preferably, a volume of the reaction chamber is increased and the reaction chamber receives the reaction liquid in an amount equal to the volume increased in the reaction chamber.

Preferably, the specific liquid is discharged from the reaction chamber and the reaction chamber receives the reaction liquid in an amount equal to an amount of the specific liquid which is discharged from the reaction chamber.

Preferably, the chemical reaction of the reaction liquid is a chemical reaction of a reactant included in the reaction liquid, and the specific liquid is a liquid having a same composition as a component of the reaction liquid in which the reactant is eliminated.

Preferably, the specific liquid is a cleaning liquid.

According to the present invention, the spaces in the reaction chamber are filled with a specific liquid which is filled in the reaction chamber before the reaction liquid is introduced in the reaction chamber. Therefore, gaseous matter such as air or the like is prevented form mixing with the reaction liquid at the time of reaction and there is an advantage that the uniformity of chemical reaction of the reaction liquid can be maintained in a good condition.

The entire disclosure of Japanese Patent Application No. 2008-109717 filed on Apr. 21, 2008 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A chemical reaction cartridge, comprising:
an elastic body as a construction material; and
a flow path and two or more chambers connected by the flow path formed inside the cartridge, wherein
the cartridge is structured so as to move or block a fluid material in the flow path or the chambers by partially sealing the flow path, the chambers or both the flow path and the chambers by applying external force to the elastic body from outside,
as one of the chambers, the cartridge has a reaction chamber,
the reaction chamber is a chamber in which a chemical reaction of a reaction liquid to be introduced in the reaction chamber is carried out, and
a specific liquid to fill a space in the reaction chamber is filled in the reaction chamber before the reaction liquid is introduced in the reaction chamber.

2. The chemical reaction cartridge as claimed in claim 1, wherein the specific liquid does not react with the reaction liquid.

3. The chemical reaction cartridge as claimed in claim 1, wherein an amount of the specific liquid exists in the reaction chamber before the reaction liquid is introduced in the reaction chamber is smaller or equal to an amount of the reaction liquid to be introduced in the reaction chamber.

4. The chemical reaction cartridge as claimed in claim 1, wherein a volume of the reaction chamber is increased and the reaction chamber receives the reaction liquid in an amount equal to the volume increased in the reaction chamber.

5. The chemical reaction cartridge as claimed in claim 1, wherein the specific liquid is discharged from the reaction chamber and the reaction chamber receives the reaction liquid in an amount equal to an amount of the specific liquid which is discharged from the reaction chamber.

6. The chemical reaction cartridge as claimed in claim 1, wherein the chemical reaction of the reaction liquid is a chemical reaction of a reactant included in the reaction liquid, and the specific liquid is a liquid having a same composition as a component of the reaction liquid in which the reactant is eliminated.

7. The chemical reaction cartridge as claimed in claim 1, wherein the specific liquid is a cleaning liquid.
